(19) United States
(12) Patent Application Publication
(10) Pub. No.: US 2019/0208451 A1
(43) Pub. Date: Jul. 4, 2019

(54) ADAPTIVELY SELECTING NETWORK CONNECTIONS AND APPLICATIONS BASED ON VEHICLE SPEED

(71) Applicant: FORD GLOBAL TECHNOLOGIES, LLC, Dearborn, MI (US)

(72) Inventors: Oliver LEI, Windsor (CA); Allen R. MURRAY, Lake Orion, MI (US)

(21) Appl. No.: 15/861,138

(22) Filed: Jan. 3, 2018

(51) Int. Cl. H04W 36/14; H04W 76/20

(52) U.S. Cl. CPC H04W 36/14; H04W 36/32; H04W 76/20

(57) ABSTRACT

A system includes a wireless interface of a cellular tower and a processor of the tower. The processor is programmed to receive a message, including vehicle speed, from a vehicle connected to the tower over first and second network protocols, and responsive to determining that the vehicle speed exceeds a predefined threshold for the first network protocol, renegotiate connection of the vehicle to the tower to use a second network protocol but not the first network protocol.

### TECHNICAL FIELD

Aspects of the disclosure generally relate to adaptively selecting network connections and applications based on vehicle speed.

### BACKGROUND

3G/4G LTE networks are widely used for cellular communication. It is planned that 5G networks will use much higher frequency bands, for example mmWave frequencies such as 28 GHz or 39 GHz. This may allow 5G networks to provide wider bandwidth for transmissions, such as 100 MHz, 200 MHz, 400 MHz, or even more. The packet throughput for 5G networks is also expected to be much higher, such as 1 Gbps or more. The cell range, however, is expected to be much smaller, such as on the order of 300 meters, as compared to the cell range for a cellular tower in an LTE network of up to 5 kilometers.

### SUMMARY

In one or more illustrative examples, a system includes a wireless interface of a cellular tower and a processor of the tower. The processor is programmed to receive a message, including vehicle speed, from a vehicle connected to the tower over first and second network protocols, and responsive to determining that the vehicle speed exceeds a predefined threshold for the first network protocol, renegotiate connection of the vehicle to the tower to use a second network protocol but not the first network protocol.

In one or more illustrative examples, a system includes a transceiver and a processor programmed to send vehicle speed in a message over a wireless connection to a cellular tower, receive a second message indicating protocol renegotiation of the connection from a first network protocol to a second network protocol responsive to the message, and avoid initiating renegotiation of the connection back to the first network protocol within a predefined time period from receipt of the second message.

In one or more illustrative examples, a method includes receiving a message, including vehicle speed, from a vehicle over a connection using a first network protocol, and, responsive to determining that the vehicle speed exceeds a predefined threshold for the first network protocol, renegotiating a connection of the vehicle to the tower to a second network protocol.

### BRIEF DESCRIPTION OF THE DRAWINGS

FIG. 1 illustrates an example system for adaptively selecting network connections and applications based on vehicle speed;

FIG. 2 illustrates an example diagram of the vehicle implementing communications features;

FIG. 3 illustrates an example diagram of the cellular tower implementing communications features;

FIG. 4 illustrates an example process for adaptively selecting network connections and applications based on vehicle speed by the vehicle;

FIG. 5 illustrates an example process for adaptively selecting network connections and applications based on vehicle speed by the cellular tower receiving vehicle speed from the vehicle; and

FIG. 6 illustrates an example process for adaptively selecting network connections and applications based on vehicle speed by the vehicle sending vehicle speed to the cellular tower.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

3G and 4G networking standards typically use low-frequency RF spectrum, e.g., 600 MHz ˜2.6 GHz. Such low frequency bands are suitable for vehicles in motion. Currently, these low bands have limited bandwidth, such as 10 MHz or up to 20 MHz. Due to the limited bandwidth, packet throughput is slow and may be limited to on the order of 5˜40 Mbps.

5G networks are expected to provide greater bandwidth and fast packet throughput. An aspect of 5G network communications standards is use of millimeter wave (mmWave) frequencies. At vehicle speeds, such frequencies may be more subject to RF Doppler effect and rapid path loss in small cell range compared to previous technologies operating at lower radio frequencies. Thus, packet throughput for vehicle communications may be affected while a vehicle is in motion at higher speeds. As a result, there may be speeds where use of 5G connectivity may be less optimal than use of other technologies, as 5G transmission may cause lower speeds than prior technologies or cause radio noise on the cellular network.

Many in-vehicle infotainment applications utilize cellular network connections. These applications, as some examples, include directions and other telematics services, WiFi Hotspot functionality for occupant devices, Internet radio services, and software over-the-air (OTA) updates.

Additional applications, such as 3D HD map updates and HD video streaming, may be realized via the additional speeds of 5G, as such applications may require high speed packet throughput. As the use of such applications requires 5G data speeds and as such applications may require data services that work in a diminished capacity at high speeds, the in-vehicle systems may be configured to adaptively select networks and applications based on vehicle speed. For instance, a telematics control unit (TCU) of the vehicle may observe speed of the vehicle and may avoid attempts to establish or utilize 5G connections in a high frequency band while the vehicle is moving at a speed exceeding a predefined threshold speed. Use of lower frequency bands of communication may be allowed regardless of the vehicle is moving at a speed exceeding the predefined threshold speed. Further aspects of the disclosure are described in detail herein.

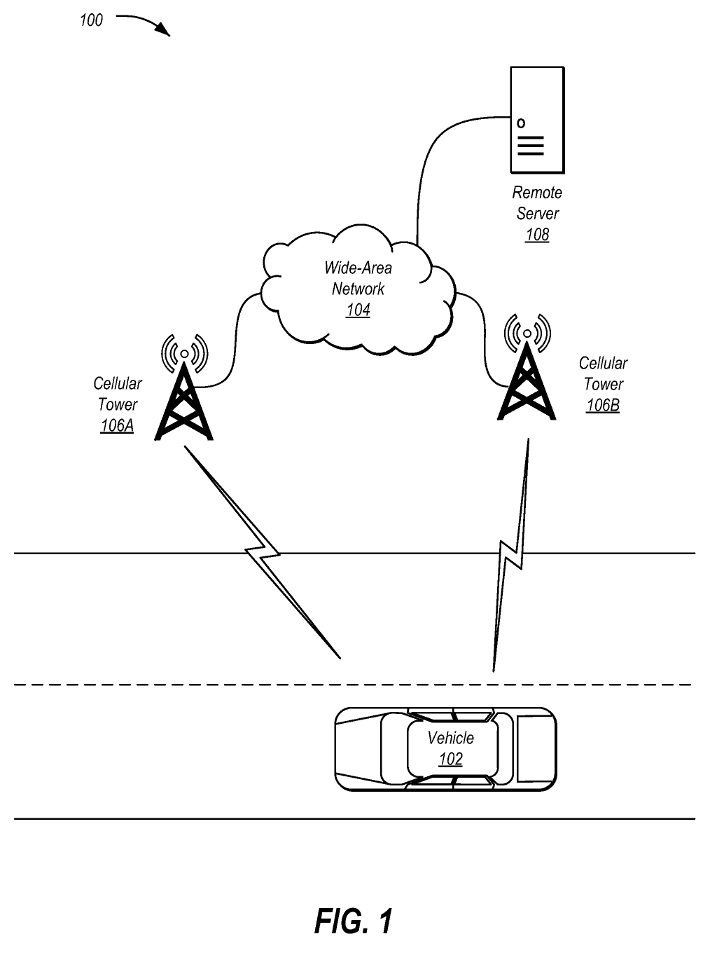

FIG. 1 illustrates an example system 100 for adaptively selecting network connections and applications based on vehicle speed. As shown, the system 100 includes a vehicle 102 in communication with a server 108 over a wide-area network 104. The vehicle 102 is configured to wireles sly communicate with cellular towers 106A and 106B (collectively 106) connected to the wide-area network 104. The server 108 is also in communication with the wide-area network 104. While an example system 100 is shown in FIG. 1, the example components as illustrated are not intended to be limiting. Indeed, the system 100 may have more or fewer components, and additional or alternative components and/or implementations may be used. As an example, the system 100 may include more or fewer vehicles 102, cellular towers 106, and/or servers 108.

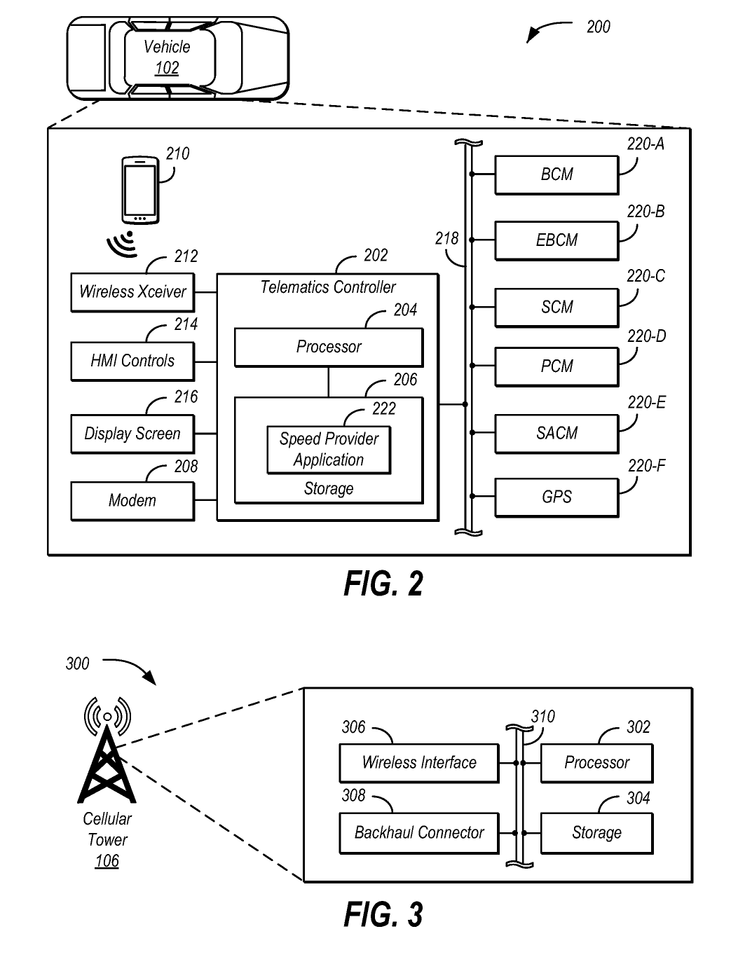

The vehicles 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. Further aspects of the functionality of the vehicle 102 are discussed in detail with respect to FIG. 2.

The wide-area network 104 may include one or more interconnected communication networks such as the Internet, a cable television distribution network, a satellite link network, a local area network, a wide area network, and a telephone network, as some non-limiting examples. By accessing the wide-area network 104, the vehicle 102 may be able to send outgoing data from the vehicle 102 to network destinations on the wide-area network 104, and receive incoming data to the vehicle 102 from network destinations on the wide-area network 104.

The cellular towers 106 may include system hardware configured to allow cellular transceivers of the vehicles 102 to access the communications services of the wide-area network 104. In an example, the cellular towers 106 may be part of a Global System for Mobile communication (GSM) cellular service provider. In another example, the cellular towers 106 may be a part of a code division multiple access (CDMA) cellular service provider. The cellular towers 106 may support various different technologies and data speeds. In an example, the cellular tower 106A may support 4G LTE, while the cellular tower 106B may also support 5G mmWave network connectivity. Further aspects of the functionality of the cellular towers 106 are discussed in detail with respect to FIG. 3.

The server 108 may include computing hardware configured to provide data services to the vehicles 102, and the vehicles 102 may support various applications that utilize network connectivity of the wide-area network 104. As some examples, these applications may include directions and other telematics services, WiFi Hotspot functionality for occupant devices, Internet radio services, software over-the-air (OTA) updates, 3D HD map updates, and HD video streaming, as some possibilities.

FIG. 2 illustrates an example diagram 200 of the vehicle 102 implementing communications features. The vehicle 102 includes a telematics controller 202 configured to communicate over the wide-area network 104. This communication may be performed using a modem 208 of the telematics controller 202. While an example vehicle 102 is shown in FIG. 2, the example components as illustrated are not intended to be limiting. Indeed, the vehicle 102 may have more or fewer components, and additional or alternative components and/or implementations may be used.

The telematics controller 202 may be configured to support voice command and BLUETOOTH interfaces with the driver and driver carry-on devices (e.g., mobile devices 210), receive user input via various buttons or other controls, and provide vehicle status information to a driver or other vehicle 102 occupants. An example telematics controller 202 may be the SYNC system provided by FORD MOTOR COMPANY of Dearborn, Mich.

The telematics controller 202 may further include various types of computing apparatus in support of performance of the functions of the telematics controller 202 described herein. In an example, the telematics controller 202 may include one or more processors 204 configured to execute computer instructions, and a storage 206 medium on which the computer-executable instructions and/or data may be maintained. A computer-readable storage medium (also referred to as a processor-readable medium or storage 206) includes any non-transitory (e.g., tangible) medium that participates in providing data (e.g., instructions) that may be read by a computer (e.g., by the processor(s) 204). In general, a processor 204 receives instructions and/or data, e.g., from the storage 206, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, PL/SQL, etc.

The telematics controller 202 may be configured to communicate with mobile devices 210 of the vehicle occupants. The mobile devices 210 may be any of various types of portable computing device, such as cellular phones, tablet computers, smart watches, laptop computers, portable music players, or other devices capable of communication with the telematics controller 202. As with the telematics controller 202, the mobile device 210 may include one or more processors configured to execute computer instructions, and a storage medium on which the computer-executable instructions and/or data may be maintained. In many examples, the telematics controller 202 may include a wireless transceiver 212 (e.g., a BLUETOOTH controller, a ZIGBEE transceiver, a Wi-Fi transceiver, etc.) configured to communicate with a compatible wireless transceiver of the mobile device 210. Additionally, or alternately, the telematics controller 202 may communicate with the mobile device 210 over a wired connection, such as via a USB connection between the mobile device 210 and a USB subsystem of the telematics controller 202.

The telematics controller 202 may also receive input from human-machine interface (HMI) controls 214 configured to provide for occupant interaction with the vehicle 102. For instance, the telematics controller 202 may interface with one or more buttons or other HMI controls 214 configured to invoke functions on the telematics controller 202 (e.g., steering wheel audio buttons, a push-to-talk button, instrument panel controls, etc.). The telematics controller 202 may also drive or otherwise communicate with one or more displays 216 configured to provide visual output to vehicle occupants, e.g., by way of a video controller. In some cases, the display 216 may be a touch screen further configured to receive user touch input via the video controller, while in other cases the display 216 may be a display only, without touch input capabilities. In an example, the display 216 may be a head unit display included in a center console area of the vehicle 102 cabin. In another example, the display 216 may be a screen of a gauge cluster of the vehicle 102.

The telematics controller 202 may be further configured to communicate with other components of the vehicle 102 via one or more in-vehicle networks 218. The in-vehicle networks 218 may include one or more of a vehicle controller area network (CAN), an Ethernet network, or a media oriented system transfer (MOST), as some examples. The in-vehicle networks 218 may allow the telematics controller 202 to communicate with other vehicle 102 systems, such as a body control module (BCM) 220-A, an electronic brake control system (EBCM) 220-B, a steering control system (SCM) 220-C, a powertrain control system (PCM) 220-D, a safety control system (SACM) 220-E, and a global positioning system (GPS) 220-F. As depicted, the controllers 220 are represented as discrete modules and systems. However, the controllers 220 may share physical hardware, firmware, and/or software, such that the functionality from multiple controllers 220 may be integrated into a single module 220, and that the functionality of various such controllers 220 may be distributed across a plurality of controllers 220.

The BCM 220-A may be configured to support various functions of the vehicle 102 related to control of current loads feeding off the vehicle 102 battery. Examples of such current loads include, but are not limited to, exterior lighting, interior lighting, heated seats, heated windshield, heated backlight, and heated mirrors. Additionally, the BCM 220-A may be configured to manage vehicle 102 access functions, such as keyless entry, remote start, and point of access status verification (e.g., closure status of the hood, doors and/or trunk of the vehicle 102).

The EBCM 220-B may be configured to control braking functions of the vehicle 102. In some examples, the EBCM 220-B may be configured to receive signal information from vehicle wheel sensors and/or drivetrain differentials, and manage anti-lock and anti-skid brake functions through control of brake line valves that adjust brake pressure from the master cylinder.

The SCM 220-C may be configured to aid in vehicle steering by augmenting or counter-acting steering effort provided to the vehicle 102 wheels. In some cases, the augmented steering effort may be provided by a hydraulic steering assist configured to provide controlled energy to the steering mechanism, while in other cases the augmented steering effort may be provided by an electric actuator system.

The PCM 220-D may be configured to perform engine control and transmission control functions for the vehicle 102. With respect to engine control, the PCM 220-D may be configured to receive throttle input and control actuators of the vehicle engine to set air/fuel mixture, ignition timing, idle speed, valve timing, and other engine parameters to ensure optimal engine performance and power generation. With respect to transmission control, the PCM 220-D may be configured to receive inputs from vehicle sensors such as wheel speed sensors, vehicle speed sensors, throttle position, transmission fluid temperature, and determine how and when to change gears in the vehicle 102 to ensure adequate performance, fuel economy, and shift quality. The PCM 220-D may further provide information over the in-vehicle networks 218, such as vehicle speed and engine RPM.

The SACM 220-E may be configured to provide various functions to improve the stability and control of the vehicle 102. As some examples, the SACM 220-E may be configured to monitor vehicle sensors (e.g., steering wheel angle sensors, yaw rate sensors, lateral acceleration sensors, wheel speed sensors, etc.), and control the BCM 220-A, SCM 220-C, and/or PCM 220-D. As some possibilities, the SACM 220-E may be configured to provide throttle input adjustments, steering angle adjustments, brake modulation, and all-wheel-drive power split decision-making over the in-vehicle network 218 to improve vehicle stability and controllability. It should be noted that in some cases, the commands provided by the SACM 220-E may override other command input. The GPS 220-F is configured to provide vehicle 102 current location and heading information for use in vehicle 102 services.

The speed provider application 222 may be an application installed to the memory of the telematics controller 202. When executed by the processor 204, the speed provider application 222 may cause the telematics controller 202 to retrieve vehicle speed information from the in-vehicle networks 218, and send the vehicle speed information to the cellular tower 106 to which the modem 208 of the vehicle 102 is currently connected. The cellular tower 106 may utilize the received vehicle speed information as a factor for determining what type of connection to use to provide data between the vehicle 102 and the cellular tower 106.

FIG. 3 illustrates an example diagram 300 of the cellular tower 106 implementing communications features. The cellular tower 106 may include and/or communicate with various types of computing apparatus to facilitate the performance of the cellular tower 106 communications functions. As shown, the cellular tower 106 includes one or more processors 302 configured to execute computer instructions, and a storage medium 304 on which the computer-executable instructions and/or data may be maintained.

The cellular tower 106 also includes a wireless interface 306 to allow the cellular tower 106 to communicate with cellular devices making use of the communications features of the cellular tower 106. The wireless interface 306 may include, for example, an antenna array. For instance, the wireless interface 306 may facilitate communication of the tower with the modem 208 of the vehicle 102 and/or with the mobile devices 210. The cellular tower 106 also includes a backhaul connector 308 interfacing the cellular tower 106 to the wide-area network 104. In many examples, the backhaul may be a T1 or T3 line, but in other cases the backhaul connection to the wide-area network 104 may be a microwave antenna to another location. The processor 302, storage 304, wireless interface 306 and backhaul connector 308 may be in communication over a data bus 310 or other electrical connection over which data can be transmitted and received.

Generally, the modem 208 or mobile device 210 radios the nearest cellular tower 106 to indicate its presence. When a call or data connection is attempted by the modem 208 or mobile device 210 to the cellular tower 106, the modem 208 or mobile device 210 sends a message via radio that is picked up by the wireless interface 306. That transmission, along with transmissions of other devices, is routed to the backhaul connector 308. Incoming calls or data is received via the backhaul connector 308 and is provided out through the wireless interface 306, where it is received by the modem 208 or mobile device 210. If the modem 208 or mobile device 210 is moving, then a handoff may be performed by the cellular tower 106 to another cellular tower 106 closer to the new location, responsive to the modem 208 or mobile device 210 indicating its presence at the other cellular tower 106.

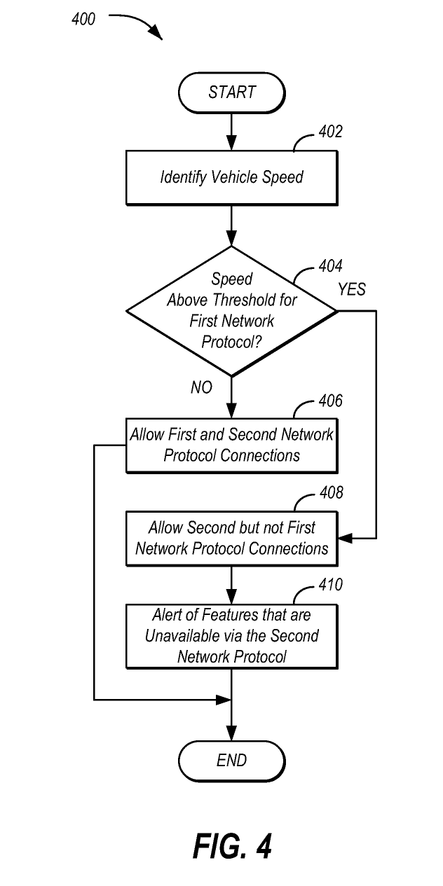

FIG. 4 illustrates an example process 400 for adaptively selecting network connections and applications based on vehicle speed by the vehicle 102. In an example, the process 400 may be performed by the vehicle 102 of the system 100. In many examples, the process 400 may be performed periodically (such as every predefined period of time or distance traveled) or based on various other trigger conditions (such as a change in vehicle speed).

At operation 402, the vehicle 102 identifies the vehicle speed. In an example, the speed provider application 222 may direct the telematics controller 202 to receive vehicle speed information from the in-vehicle networks 218.

The vehicle 102 determines whether the vehicle speed exceeds a threshold speed for a first network protocol at 404. In an example, the speed provider application 222 may direct the telematics controller 202 to retrieve the threshold speed from the storage 206, and compare the threshold speed to the current vehicle speed. As one possibility, the first network protocol may be 5G, and the storage 206 may maintain a maximum vehicle speed for use of 5G. If the vehicle speed exceeds the threshold, control passes to operation 408. Otherwise, control passes to operation 406.

At 406, the vehicle 102 allows first and second network protocol connections. In an example, as the vehicle 102 is traveling at a speed below the threshold, the vehicle 102 may allow for use of connections using the first network protocol. Moreover, the vehicle 102 may also allow for use of connections over a second network protocol that is not limited by the threshold speed (e.g., 3G or 4G/LTE). After operation 406, the process 400 ends.

At operation 408, the vehicle 102 allows first speed connections but not second speed connections. In an example, the vehicle 102 may allow for use of connections using the second network protocol. (e.g., 3G or 4G/LTE) but not use of connections using the first network protocol (e.g., 5G).

At 410, the vehicle 102 provides an alert of features that are unavailable via first speed connections. For instance, the vehicle 102 may generate an alert indicating that data-intensive applications, such as 3D HD map updates or HD video streaming, may be unavailable due to the speed of the vehicle 102. This alert may be provided, in one example, by the speed provider application 222 to the display screen 216 of the telematics control 202. In another example, the alert may be provided via audio output to the user via an audio system of the vehicle 102. After operation 410, the process 400 ends.

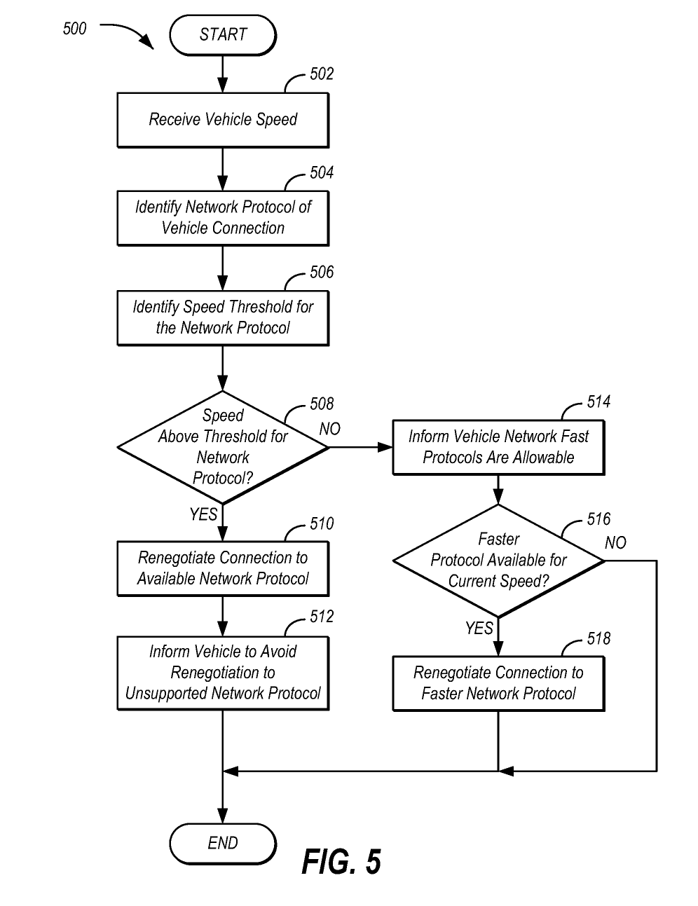

FIG. 5 illustrates an example process 500 for adaptively selecting network connections and applications based on vehicle speed by the cellular tower 106 receiving vehicle speed from the vehicle 102. In an example, the process 500 may be performed by the cellular tower 106 of the system 100.

At operation 502, the cellular tower 106 receives vehicle speed. In an example, the speed provider application 222 of the telematics controller 202 of the vehicle 102 retrieves the vehicle speed from the in-vehicle network 218, and sends the vehicle speed information to the cellular tower 106. This sending of speed information may be performed periodically (such as every predefined period of time or distance traveled) or based on various other trigger conditions (such as a change in vehicle speed). The cellular tower 106, accordingly, receives the speed information sent from the vehicle 102.

At 504, the cellular tower 106 identifies a network protocol of the network connection of the vehicle 102 to the cellular tower 106. In an example, the cellular tower 106 may maintain information in the storage 304 indicative of the network protocol on which the vehicle 102 is currently camped or otherwise connected to the cellular tower 106.

The cellular tower 106 identifies a speed threshold for the identified network protocol at 506. In an example, based on the network protocol, the cellular tower 106 may further access the storage 206 to retrieve a vehicle speed threshold above which the vehicle 102 is disallowed from using the network protocol.

At 508, the cellular tower 106 determines whether the vehicle speed exceeds the speed threshold. The cellular tower 106 may, accordingly, compare the vehicle speed received at operation 502 with the vehicle speed threshold identified at operation 506. If the vehicle speed exceeds the threshold, control passes to operation 510. If, however, the vehicle speed does not exceed the threshold, control passes to operation 514.

At operation 510, the cellular tower 106 renegotiates the connection to an available network protocol for the vehicle speed. In an example, the cellular tower 106 may identify another network protocol that is allowable for use for the vehicle speed. In one specific example, the vehicle speed may be prevented use of 5G networks, but may still be allowed use of 4G/LTE network protocols. The cellular tower 106 may also negotiate the connection to the fastest network protocol available for the vehicle speed. For instance, the cellular tower 106 may utilize the network connection type with the best bandwidth or packets per second that meets with the current vehicle speed. Accordingly, the network connection of the vehicle 102 may be adjusted to conform with the vehicle speed.

At 512, the cellular tower 106 informs the vehicle 102 to avoid renegotiation to an unsupported network protocol. In an example, the cellular tower 106 may send a message to the vehicle 102 to inform the vehicle 102 not to determine, for a predetermined period of time, that it may be possible to use a faster network protocol and attempt to utilize a protocol that is barred by the current vehicle speed. In one example, the message may be sent as a short message service (SMS) message. In one example, the vehicle 102 may receive the message and may avoid renegotiations for a predefined period of time or distance of travel. Thus, if the vehicle speed is identified by the cellular tower 106 to be below a threshold speed, both fast (e.g., mmWave) and slow (e.g., sub-6 GHz) network protocols will be used by the vehicle 102. However, if the vehicle speed is identified by the cellular tower 106 to be above the threshold, only slow network protocols will be used. After operation 512, the process 500 ends.

At 514, the cellular tower 106 informs the vehicle 102 to avoid renegotiation to an unsupported network protocol. In an example, the cellular tower 106 may send a message to the vehicle 102 to inform the vehicle 102 that it is permissible to determine to use a faster network protocol, regardless of whether a message was recently received to avoid use of a faster protocol.

At operation 516, the cellular tower 106 determines whether a faster network protocol is available for the current vehicle speed. For instance, it may have been determined at operation 508 that the vehicle speed is not above the threshold speed for the currently negotiated network protocol. However, it may be possible for the vehicle 102 to use another network protocol that is faster or that provides greater throughput even with the current vehicle speed. Accordingly, the cellular tower 106 determines whether any other network protocols are available that are faster, and if so, passes control to operation 518. If not, the process 500 ends.

The cellular tower 106 negotiates the connection to the fastest network protocol available for the vehicle speed at 518. For instance, the cellular tower 106 may utilize the network connection type determined at operation 514 that has the best bandwidth or packets per second and meets with the current vehicle speed. Accordingly, the network connection of the vehicle 102 may be adjusted to conform with the vehicle speed. After operation 518, the process 500 ends.

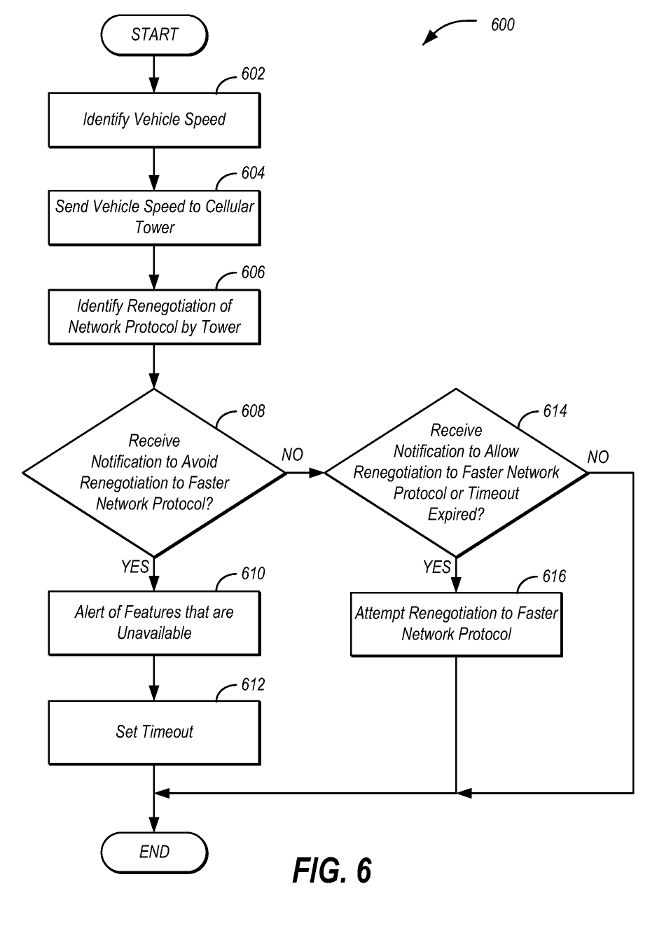

FIG. 6 illustrates an example process 600 for adaptively selecting network connections and applications by a vehicle 102 based on sending vehicle speed from the vehicle 102 to the cellular tower 106. In an example, the process 600 may be performed by the vehicle 102 of the system 100.

At 602, the vehicle 102 identifies the vehicle speed. In an example, the speed provider application 222 may direct the telematics controller 202 to receive vehicle speed information from the in-vehicle networks 218.

At 604, the vehicle 102 sends the vehicle speed to the cellular tower 106. In an example, the speed provider application 222 of the telematics controller 202 of the vehicle 102 retrieves the vehicle speed from the in-vehicle network 218, and sends the vehicle speed information to the cellular tower 106. This sending of speed information may be performed periodically (such as every predefined period of time or distance traveled), or based on various other trigger conditions (such as a change in vehicle speed). The cellular tower 106, accordingly, receives the speed information sent from the vehicle 102.

At 606, the vehicle 102 identifies a renegotiation of the network protocol by the cellular tower 106. In an example, the cellular tower 106 to which the modem 208 of the vehicle 102 is connected may identify another network protocol that is allowable for use for the vehicle speed. In one specific example, the vehicle speed may prevent use of 5G networks, but may still be allowed use of 4G/LTE network protocols. The cellular tower 106 may also negotiate the connection to the fastest network protocol available for the vehicle speed. For instance, the cellular tower 106 may utilize the network connection type with the best bandwidth or packets per second that meets with the current vehicle speed. Accordingly, the network connection of the vehicle 102 may be adjusted to conform with the vehicle speed. The modem 208 of the vehicle 102 may, accordingly, identify this change in the connected network protocol based on messaging between the modem 208 and the cellular tower 106.

At 608, the vehicle 102 determines whether a notification was received to avoid renegotiation of the connection between the modem 208 and the cellular tower 106 to a faster but unsupported network protocol. If such a message was received, control passes to operation 610. Otherwise, control passes to operation 614.

At 610, the vehicle 102 provides an alert of features that are unavailable via first speed connections. For instance, the vehicle 102 may generate an alert indicating that data-intensive applications, such as 3D HD map updates or HD video streaming, may be unavailable due to the speed of the vehicle 102. This alert may be provided, in one example, by the speed provider application 222 to the display screen 216 of the telematics control 202. In another example, the alert may be provided via audio output to the user via an audio system of the vehicle 102.

At operation 612, the vehicle 102 sets a predefined timeout period. The predefined timeout period may be, in an example, an amount of time such as ten minutes. During the predefined timeout period, the vehicle 102 may avoid using the first speed connections. After operation 612, the process 600 ends.

At 614, the vehicle 102 determines whether a notification was received to allow use of the connection between the modem 208 and the cellular tower 106 using a faster higher frequency network protocol. Other conditions may also allow the use of the connection using the faster higher-frequency network protocol, such as a vehicle keyoff and keyon, and/or if the vehicle 102 passes to another cellular tower 106. If such a message was received or condition was identified, control passes to operation 616. Otherwise, the process 600 ends.

At 616, the vehicle 102 attempts to renegotiate to a faster network protocol. In an example, the modem 208 of the vehicle 102 may request for the cellular tower 106 to change the connection of the modem 208 to a network connection type with the best bandwidth or packets per second that is available from the cellular tower 106. After operation 616, the process 600 ends.

Variations on the processes 400, 500, and 600 are possible. As one possibility, the storage 206 may maintain different threshold speeds for multiple possible network protocol that the vehicle 102 is compatible with using via the cellular tower 106. For instance, the storage 206 may maintain a maximum speed for use of 4G/LTE low frequency, and a maximum speed for use of 5G in mmWave, and comparisons for each of these speeds may be performed. In such an example, if the vehicle speed exceeds any of these thresholds, then control may pass to operation 408 to identify which protocols may not be used, and may pass to operation 410 to indicate what application specific to the disallowed protocols that may be unavailable.

As another possible variation, as part of or after operation 406, if the alert was previously provided in operation 410, a further alert may be provided by the speed provider application 222 to the display screen 216 or the audio system to indicate that the data-intensive applications are again available for use.

Computing devices described herein, generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined not with reference to the above description, but with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a wireless interface of a cellular tower; and
a processor of the tower, programmed to
receive a message, including vehicle speed, from a vehicle connected to the tower over first and/or second network protocols, and
responsive to determining that the vehicle speed exceeds a predefined threshold for the first network protocol, renegotiate connection of the vehicle to the tower to use a second network protocol but not the first network protocol.

2. The system of claim 1, wherein the processor is further programmed to responsive to the renegotiate of the connection of the vehicle to the second network protocol, send a message to the vehicle to instruct the vehicle to avoid renegotiating back to the first network protocol.

3. The system of claim 1, wherein the message is configured to cause the vehicle to provide an alert indicating that vehicle functionality requiring the first network protocol is unavailable.

4. The system of claim 1, wherein the processor is further programmed to, responsive to determining that the vehicle speed fails to exceed the predefined threshold for the first network protocol, identify whether any faster protocols than the first network protocol are available for the vehicle, and, when so, renegotiate the connection to a faster network protocol.

5. The system of claim 1, wherein the predefined threshold corresponds to the first network protocol, and the processor is further programmed to identify the predefined threshold according to an identification that the connection uses the first network protocol.

6. The system of claim 1, wherein the first network protocol uses a higher wireless frequency than used by the second network protocol.

7. A system comprising:
a transceiver; and
a processor programmed to
send vehicle speed in a message over a wireless connection to a cellular tower,
receive a second message indicating protocol renegotiation of the connection from a first network protocol or from both a first network protocol and a second network protocol to a second network protocol responsive to the message, and
avoid initiating renegotiation of the connection back to the first network protocol within a predefined time period from receipt of the second message.

8. The system of claim 7, wherein the processor is further programmed to provide an alert indicating that vehicle functionality requiring the first network protocol is unavailable.

9. The system of claim 7, wherein the predefined time period expires responsive to the connection moving from the cellular tower to a second cellular tower.

10. The system of claim 7, wherein the predefined time period expires responsive to a vehicle key cycle.

11. The system of claim 7, wherein the processor is further programmed to receive the vehicle speed over an in-vehicle network.

12. A method comprising:
receiving a message including vehicle speed from a vehicle over a connection to a cellular tower; and
responsive to the tower determining that the vehicle speed exceeds a predefined threshold for a first network protocol, renegotiating, by the tower, the connection of the vehicle to the tower from using both a first network protocol and a second network protocol to using only the second network protocol.

13. The method of claim 12, further comprising, responsive to the renegotiating of the connection of the vehicle to the second network protocol, sending a second message to the vehicle to instruct the vehicle to avoid using to the first network protocol for a predefined time period.

14. The method of claim 13, wherein the second message is configured to cause the vehicle to provide an alert indicating that vehicle functionality requiring the first network protocol is unavailable.

15. The method of claim 12, further comprising responsive to determining that the vehicle speed fails to exceed the predefined threshold for the first network protocol, identifying whether any faster protocols than the first network protocol are available for the vehicle, and, when so, renegotiate the connection to a faster network protocol.

16. The method of claim 12, wherein the predefined threshold corresponds to the first network protocol, and further comprising identifying the predefined threshold according to an identification that the connection uses the first network protocol.

17. The method of claim 12, wherein the first network protocol uses a higher wireless communications frequency than used by the second network protocol.
